(19) United States
(12) Patent Application Publication
(10) Pub. No.: US 2007/0267501 A1
(43) Pub. Date: Nov. 22, 2007

(54) Multipurpose optical reader

(75) Inventors: Brian L. Jovanovski, Syracuse, NY (US); William H. Havens, Syracuse, NY (US); Edward C. Bremer, Victor, NY (US); Timothy P. Meier, Camillus, NY (US); Ynjiun P. Wang, Cupertino, CA (US)

Correspondence Address: HAND HELD PRODUCTS, INC., 700 VISIONS DRIVE, P.O. BOX 208, SKANEATELES FALLS, NY, 13153-0208, US

(73) Assignee: Hand Held Products, Inc.

(21) Appl. No.: 11/495,417

(22) Filed: Jul. 28, 2006

Related U.S. Application Data
(60) Provisional application No. 60/801,260, filed on May 18, 2006.

(51) Int. Cl. G06K 7/10

(52) U.S. Cl. 235/472.01; 235/462.07

(57) ABSTRACT

An optical reading device for collecting and processing symbology data comprising: an image sensor array of pixels for converting light reflected from a target containing a machine readable indicia into output signals representative thereof, the image sensor being operated in a global shutter mode wherein all or substantially all of the pixels in the array are exposed simultaneously during an exposure time; receive optics for directing light from the target to the image sensor array, the optics having a receive optics optical axis; a processor for decoding the output signals; an illumination source for generating illumination light illuminating the target and illumination optics for directing the illumination light onto the target; a housing encapsulating the image sensor array, receive optics and illumination source; wherein the processor decodes in a first mode to continuously process available output signals automatically and a second mode to output signal in response to an activation event.

### RELATED APPLICATIONS

This application claims the priority date of U.S. Provisional Application Ser. No. 60/801,260, entitled “MULTIPURPOSE IMAGE READER” filed May 18, 2006.

### FIELD OF THE INVENTION

The present invention relates to optical reading devices, and more particularly to an optical reading device that useful for multipurpose operation.

### BACKGROUND

Optical reading devices typically read data represented by symbols. For instance a bar code symbol is an array of rectangular bars and spaces that are arranged in a specific way to represent elements of data in machine readable form. Optical reading devices typically transmit light onto a symbol and receive light reflected off of the symbol. The received light is interpreted to extract the data represented by the symbol.

One-dimensional (1D) optical bar code readers are characterized by reading data that is encoded along a single axis, in the widths of bars and spaces, so that such symbols can be read from a single scan along that axis, provided that the symbol is imaged with a sufficiently high resolution along that axis.

In order to allow the encoding of larger amounts of data in a single bar code symbol, a number of 1 D stacked bar code symbologies have been developed which partition encoded data into multiple rows, each including a respective 1D bar code pattern, all or most all of which must be scanned and decoded, then linked together to form a complete message. Scanning still requires relatively high resolution in one dimension only, but multiple linear scans are needed to read the whole symbol.

A class of bar code symbologies known as two dimensional (2D) matrix symbologies have been developed which offer greater data densities and capacities than 1 D symbologies. 2D matrix codes encode data as dark or light data elements within a regular polygonal matrix, accompanied by graphical finder, orientation and reference structures.

Often times a bar code reader may be portable and wireless in nature thereby providing added flexibility. In these circumstances, such portable bar code readers form part of a wireless network in which data collected within the terminals is communicated to a host computer situated on a hardwired backbone via a wireless link. For example, the portable bar code readers may include a radio or optical transceiver for communicating with a network computer.

Conventionally, a bar code reader, whether portable or otherwise, may include a central processor which directly controls the operations of the various electrical components housed within the bar code reader. For example, the central processor controls detection of keyboard entries, display features, wireless communication functions, trigger detection, and bar code read and decode functionality.

Efforts regarding such systems have led to continuing developments to improve their versatility, practicality and efficiency.

### BRIEF DESCRIPTION OF THE DRAWINGS

FIG. 1 is a fragmentary partially cutaway side view of an exemplary reader in accordance with the invention.

FIG. 2 is a top view of the exemplary imaging module and illumination source of FIG. 1.

FIG. 3 is a perspective assembly view of an exemplary imaging module in accordance with the invention.

FIG. 4 is a block schematic diagram of an exemplary optical reader in accordance with the invention.

FIG. 5 is a block schematic diagram of an exemplary optical reader in accordance with the invention.

FIG. 6 is a block schematic diagram of an exemplary current driving circuit in accordance with the present invention.

FIG. 7 is a block schematic diagram of an exemplary microcontroller in accordance with the present invention.

FIG. 8 is a schematic diagram of an exemplary current driving circuit in accordance with the present invention.

FIG. 9 is a graph of a drive signal for an exemplary illumination current source in accordance with the present invention.

FIG. 10 is a graph illustrating pulse width modulation of an exemplary drive signal for an illumination current source in accordance with the present invention.

FIG. 11 is a schematic diagram of a control circuit for an exemplary laser aimer light source in accordance with the present invention.

FIG. 12 is a block diagram of an exemplary image sensor in accordance with the present invention.

FIG. 13 is a block diagram of an exemplary image sensor in accordance with the present invention.

FIG. 14 is a block schematic diagram of an exemplary image sensor in accordance with the present invention.

FIG. 15 is an exemplary flow chart of a process for decoding an image in accordance with the invention.

FIG. 16 is an exemplary timing diagram used in the global shutter architecture in accordance with the invention.

FIG. 17 is an illustration of two views of an exemplary image reader stand in accordance with the present invention.

FIG. 18 is an illustration of an exemplary image reader system in accordance with the present invention.

FIG. 19 is an illustration of an exemplary image reader system at a point of transaction in accordance with the present invention.

### DETAILED DESCRIPTION

Reference will now be made to exemplary embodiments of the invention which are illustrated in the accompanying drawings. This invention, however, may be embodied in various forms and should not be construed as limited to the embodiments set forth herein. Rather, these representative embodiments are described in detail so that this disclosure will be thorough and complete, and will fully convey the scope, structure, operation, functionality, and potential of applicability of the invention to those skilled in the art. Wherever possible, the same reference numbers will be used throughout the drawings to refer to the same or like parts. The term “scan” or “scanning” use herein refers to reading or extracting data from an information bearing indicia or symbol.

An optical reader system in accordance with the invention may be adapted for reading symbol indicia for numerous functions. A detailed description of transaction terminals and their operation is disclosed in commonly owned published United States Patent Application Publication No. 20030029917 entitled OPTICAL READER FOR IMAGING MODULE and United States Patent Application Publication No. 20030019934 entitled OPTICAL READER AIMING ASSEMBLY COMPRISING APERTURE, United States Patent Application Publication No. 20040134989 entitled DECODER BOARD FOR AN OPTICAL READER UTILIZING A PLURALITY OF IMAGING FORMATS which are hereby incorporated herein by reference.

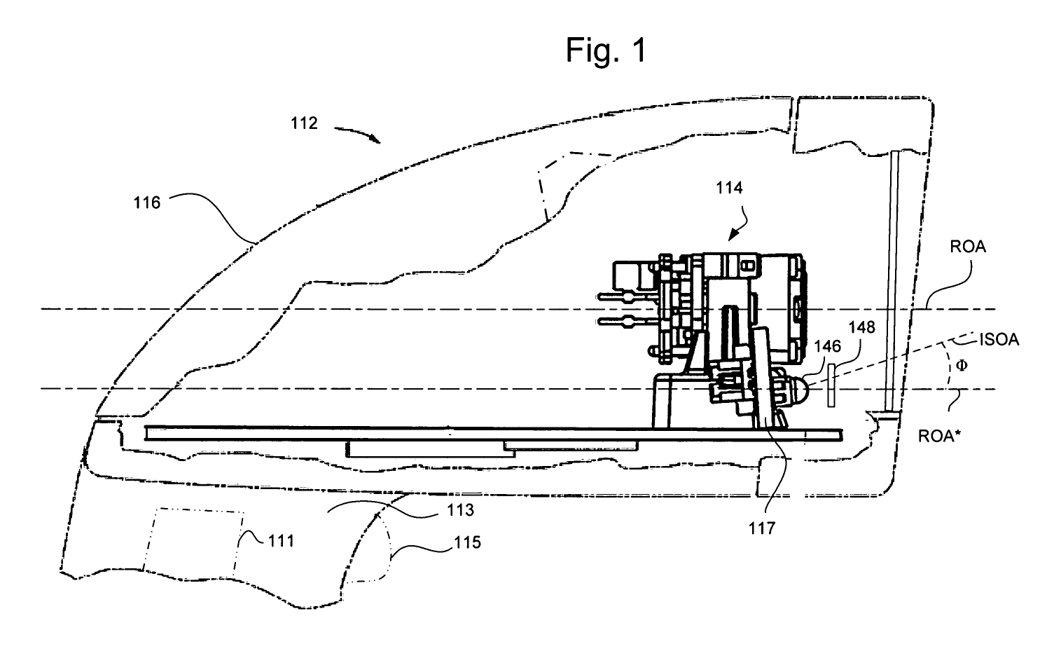

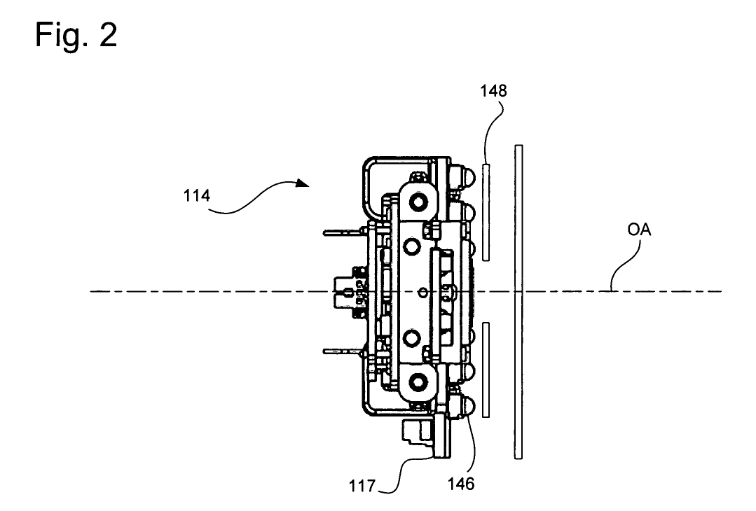

Referring to FIGS. 1, 2, 3 and 4, an optical or indicia reader 112 may have a number of subsystems for capturing and reading images, some of which may have symbol indicia provided therein. Reader 112 may have an imaging reader assembly 114 (including an image sensor 154) provided within a housing 116 which may be configured to be mounted or hand held. Housing 116 may be integrated with a handle 113 for the reader to be a portable, hand held optical reading device. For additional portability, a battery 111 may be utilized to provide power to the reader. Image reader assembly 114 has imaging reader imaging optics having an optical axis (OA) for receiving light reflected off of a target T. A light bar 117 may be positioned off of the optical axis of the imaging reader assembly or imaging reader imaging optics. The light bar 117 may have one or more illumination sources 146o, 146i for illuminating a target T. The target may be any object or substrate which may bear a 1 D or 2D bar code indicia or text or other machine readable indicia. A trigger 115 may be used for controlling full or partial operation of the reader 112. Imaging reader assembly 114 may also have an aiming generator light source 132, aiming aperture 133, aiming optics 136, an illumination source 146, illumination optics 148 and imaging optics 152.

The optical axis ISOA of an illumination source(s) may be angled or tilted at an angle φ to a line ROA* drawn essentially parallel to the imager assembly optical axis ROA. φ may be any angle to improve reading performance of the reader, such as between about zero degrees to about 8 degrees, with on exemplary angle being about 4 degrees. The improved reading performance may include reduction in the amount of specular reflection from the illumination source back to the imager sensor 154 through imaging optics 152. In the present exemplary embodiment, the illumination source assembly is comprised of a “light bar” printed circuit board having six high intensity LED's. The LEDs may be any of a number of available on the market, such as model number LaE63F available from OSRAM GmbH. The LED's are arranged on the circuit board in groups of three separated on either side of the imaging subassembly in a manner such that the emitted radiation is generally horizontally symmetrical about the center of the long axis of the light bar. To this end, the LED's are positioned in a manner to provide a more evenly distributed light field over the field of view (FOV). Displacing the light bar from the illumination optics reduces specular reflection back into the image sensor while providing an illumination field.

In an exemplary embodiment, LEDs 146 may have different viewing angles and/or intensity output levels (illumination emission profiles) for managing the flatness of the illumination field at the target. For example, inner LEDs 146i may have 60 degree viewing angles while outer LEDs 146o may have 30 degree viewing angles. The inner LEDs may also have more or less light intensity than the outer LEDs. Also, light from each LED may be aimed and/or concentrated using a supplementary optic to focus on different sections of the field of view of the imager. In an exemplary embodiment, as a target comes into view, it may be tracked through software or by other methods and only the illumination aimed at the target's location is turned on to capture the image. This may allow the system to save current by not turning on all of the illumination, but also, more current can be used by the LED or LEDs that are aimed at the target area, thereby allowing a higher light intensity which may allow lower integration time and increased motion tolerance.

Illumination and aiming light sources with different colors may be employed. For example, in one such embodiment the image reader may include white and red LEDs, red and green LEDs, white, red, and green LEDs, or some other combination chosen in response to, for example, the color of the symbols most commonly imaged by the image reader. Different colored LEDs may be each alternatively pulsed at a level in accordance with an overall power budget.

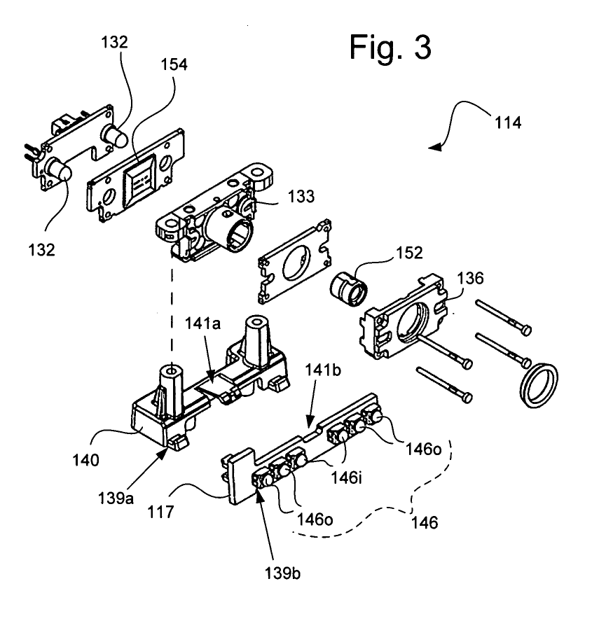

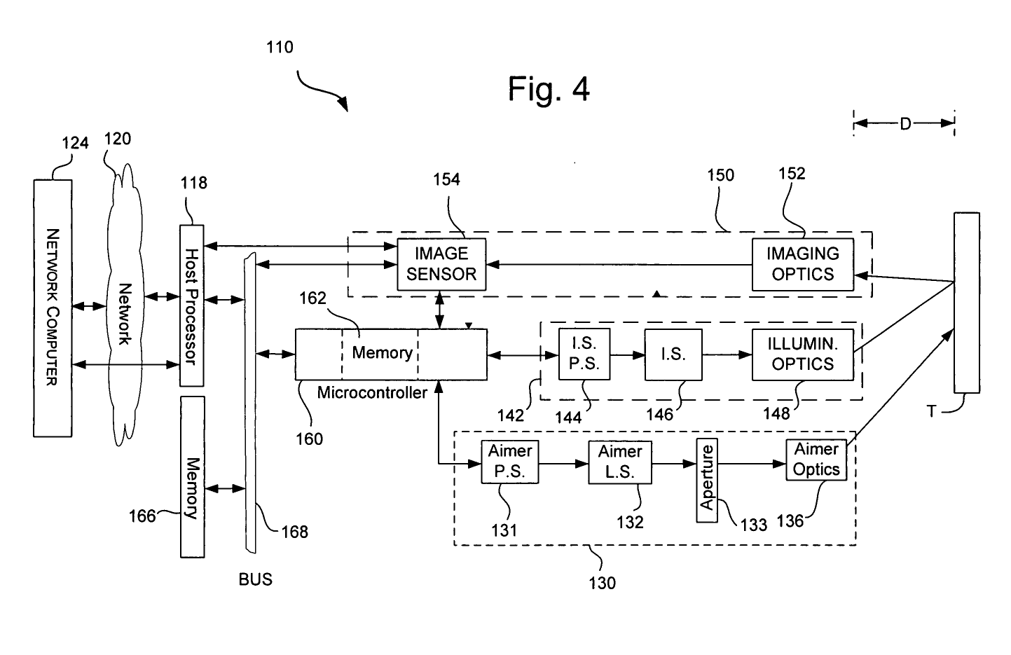

In FIG. 3, the illustrated imaging reader assembly 114 may include a support bracket 140 having tabs, 139a, latch arms 141a or other means for mating with 139b, cutouts 141b or other means on the surface of the light bar 117 for latching and locating the light bar to the bracket so that the created illumination pattern intersects the field of view at the plane of optimum focus of the imaging assembly 150 (FIG. 4), which is seated above the latch arm 141a to prevent unlatching of the light bar during handling or drops.

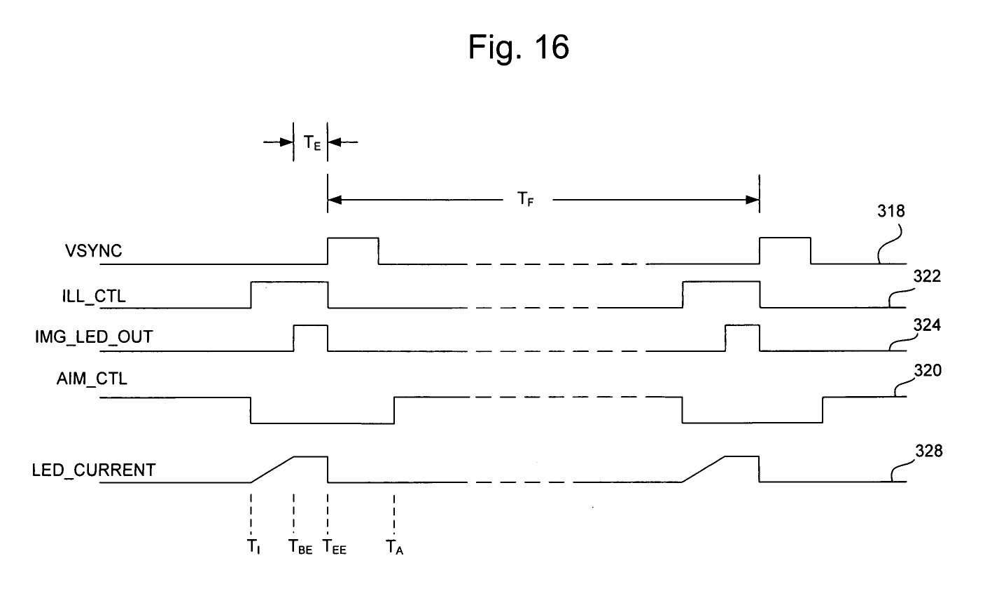

Referring to FIG. 4 and FIG. 16, imaging system 110 may include a reader 112 connected via wired or wireless connection to a host processor 118 which may be connected via wire or wireless connection to a network 120 which may be connected to one or more network computers 124. Reader 112 may include a number of components, such as an aiming pattern generator 130 and optics 136 adapted to generate an aiming pattern for assisting an operator to align target T coincident with the field of view of an imaging subassembly 150.

Aiming pattern generator 130 may include a power supply 131, light source 132, and optics 136 to create an aiming light pattern projected on or near the target which spans a portion of the receive optical system 150 operational field of view with the intent of assisting the operator to properly aim the scanner at the bar code pattern that is to be read. A number of representative generated aiming patterns are possible and not limited to any particular pattern or type of pattern, such as any combination of rectilinear, linear, circular, elliptical, etc. figures, whether continuous or discontinuous, i.e., defined by sets of discrete dots, dashes and the like.

Generally, the light source may comprise any light source which is sufficiently small or concise and bright to provide a desired illumination pattern at the target. For example, light source 132 for aiming generator 130 may comprise one or more LEDs, such as part number NSPG300A made by Nichia Corporation.

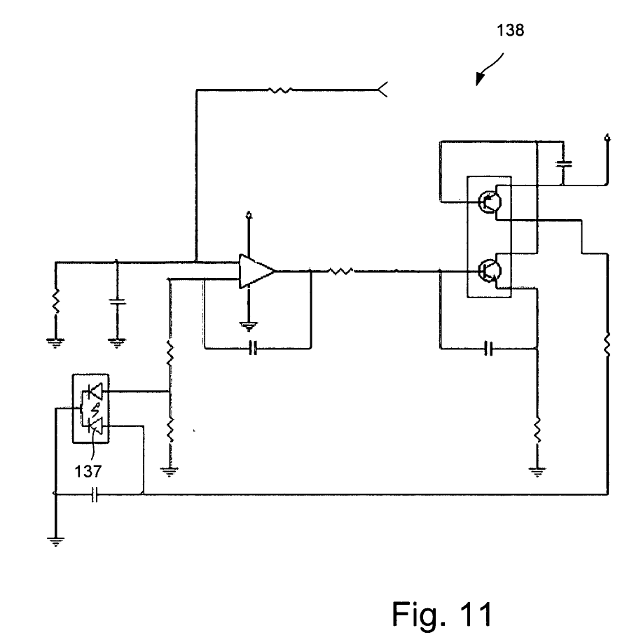

The light beam from the LEDs 132 may be directed towards an aperture 135 located in close proximity to the LEDs. An image of this back illuminated aperture 133 may then be projected out towards the target location with a lens 136. Lens 136 may be a spherically symmetric lens, a cylindrical lens or an animorphic lens with two different radii of curvature on their orthogonal lens axis. Alternately, the aimer pattern generator may be a laser pattern generator wherein the light sources 132 may be comprised of one or more visible laser diodes 137 (FIG. 11) such as those available from Rohm.

Aimer optics 136 for a laser diode 137 aimer light source may include a collimating lens and an interference pattern generating element, such as a holographic element or diffractive optic element that may include one or more diffractive gratings, or a Fresnel type optic element all of which may be fabricated with the desired pattern in mind. Examples of each of these types of elements are known, commercially available items and may be purchased, for example, from Digital Optics Corp. of Charlotte, N.C. among others. Elements of some of these types and methods for making them are also described in U.S. Pat. No. 4,895,790 (Swanson); U.S. Pat. No. 5,170,269 (Lin et al) and U.S. Pat. No. 5,202,775 (Feldman et al), which are hereby incorporated herein by reference.

Image reader may include an illumination assembly 142 for illuminating target area T. Illumination assembly 142 may also include a power supply 144, an illumination source 146 and illumination optics 148, which may also be located remote from imaging device reader 112 or the housing 116 at a location so as to reduce specular reflection of emitted light into the image sensor 154.

Illumination optics 148 may be provided to alter the light emanating from the illumination source 146. Illumination optics 148 may include one or more lenses, diffusers, wedges, reflectors, prisms or a combination of such elements, for directing light from illumination source in the direction of target T.

Image reader may include imaging optics 152 and an image sensor 154 to read, capture or collect an image or picture from light scattered from target T and passed through the imaging optics 152. Optics 152 may include one or more lenses for receiving and focusing an image of object T onto image sensor 154.

Image sensor 154 may be a two-dimensional array of pixels adapted to operate in a global shutter or full frame operating mode which is a color or monochrome 2D CCD, CMOS, NMOS, PMOS, CID, CMD, etc. solid state image sensor which may contain an array of light sensitive photodiodes (or pixels) that convert incident light energy into electric charge. Solid state image sensors allow regions of a full frame of image data to be addressed. An exemplary CMOS sensor is model number MT9V022 from Micron Technology Inc.

In electronic shutter operating mode known as a full frame (or global) shutter the entire imager is reset before integration to remove any residual signal in the photodiodes. The photodiodes (pixels) then accumulate charge for some period of time (exposure period), with the light collection starting and ending at about the same time for all pixels. At the end of the integration period (time during which light is collected), all charges are simultaneously transferred to light shielded areas of the sensor. The light shield prevents further accumulation of charge during the readout process. The signals are then shifted out of the light shielded areas of the sensor and read out.

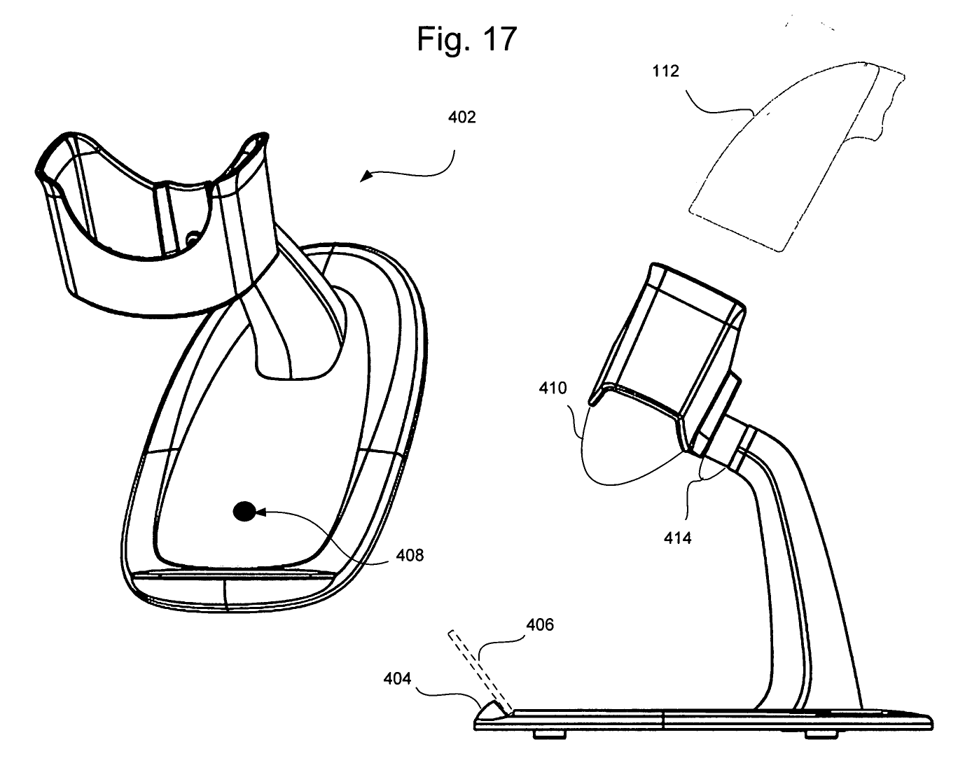

Features and advantages associated with incorporating a color image sensor in an imaging device, and other control features which may be incorporated in a control circuit are discussed in greater detail in U.S. Pat. No. 6,832,725 entitled “An Optical Reader Having a Color Imager” incorporated herein by reference. It is to be noted that the image sensor 154 may read images with illumination from a source other than illumination source 146, such as by illumination from a source located remote from the reader such as an illumination source 414 (FIG. 17) on a stand for holding the reader.

The output of the image sensor may be processed utilizing one or more functions or algorithms to condition the signal appropriately for use in further processing downstream, including being digitized to provide a digitized image of target T.

Microcontroller 160, may perform a number of functions, such as controlling the amount of illumination provided by illumination source 146 by controlling the output power provided by illumination source power supply 144. Microcontroller 160 may also control other functions and devices. An exemplary microcontroller 160 is a CY8C24223A made by Cypress Semiconductor Corporation, which is a mixed-signal array with on-chip controller devices designed to replace multiple traditional MCU-based system components with one single-chip programmable device. It may include configurable blocks of analog and digital logic, as well as programmable interconnects. Microcontroller 160 may include a predetermined amount of memory 162 for storing data.

The components in reader 112 may be connected by one or more bus 168 or data lines, such as an Inter-IC bus such as an I²C bus, which is a control bus that provides a communications link between integrated circuits in a system. This bus may connect to a host computer in relatively close proximity, on or off the same printed circuit board as used by the imaging device. I²C is a two-wire serial bus with a software-defined protocol and may be used to link such diverse components as the image sensor 154, temperature sensors, voltage level translators, EEPROMs, general-purpose I/O, A/D and D/A converters, CODECs, and microprocessors/microcontrollers.

The functional operation of the host processor 118 involves the performance of a number of related steps, the particulars of which may be determined by or based upon certain parameters stored in memory 166, which may be any one of memory types, such as RAM, ROM, EEPROM, etc. Some parameters may be stored in memory 162 provided as part of the microcontroller 160. One of the functions of the host processor 118 may be to decode machine readable symbology provided within the target or captured image. One dimensional symbologies may include very large to ultra-small, Code 128, Code 39, Interleaved 2 of 5, Codabar, Code 93, Code 11, UPC, EAN, and MSI. Stacked 1 symbologies may include PDF, Code 16K and Code 49. 2D symbologies may include Aztec, Datamatrix, Maxicode, and QR Code. UPC/EAN bar codes are standardly used to mark retail products throughout North America, Europe and several other countries throughout the worlds. Decoding is a term used to describe the interpretation of a machine readable code contained in an image projected on the image sensor 154. The code has data or information encoded therein. Information respecting various reference decode algorithm is available from various published standards, such as by the International Standards Organization (“ISO”).

Operation of the decoding, which may be executed in a user or factory selectable relationship to a scanning routine, may be governed by parameters which control the codes which are enabled for processing as a part of an autodiscrimination process, whether decoding is to be continuous or discontinuous, etc. Permitted combinations of scanning and decoding parameters together define the scanning-decoding relationships or modes which the reader will use. In the continuous mode (also referred to as continuous scanning mode, continuous streaming mode, streaming mode, fly-by scanning mode, on the fly scanning mode or presentation mode) the reader is held in a stationary manner and targets (such as symbols located on packages) are passed by the reader 112. In the continuous mode, the reader takes continuous image exposures seriatim and continuously decodes or attempts to decode some or all of these images. In the continuous mode exposure times and decoding times are limited.

Discontinuous mode is a mode wherein scanning and/or decoding stops or is interrupted and must have an actuation event, such as pulling of a trigger 115, to restart. An exemplary utilization of the reader in discontinuous mode is via hand held operation. While triggered, the image reader may expose images continuously and decode images continuously. Decoding stops once the image reader is no longer triggered. Exposing of images, however may continue. In the discontinuous mode, the exposure time, decoding time out limits and decoding aggressiveness may be increased more than those set for continuous mode. It is to be noted that the discontinuous mode is typically initiated because the operator knows a symbol is present. The decoder therefore may forego making a determination of the presence of a symbol because a symbol is presumed to be in the field of view. Discontinuous mode may provide longer range scanning than the continuous mode.

Switching between continuous and discontinuous modes may be accomplished by use of a trigger 115 located on the reader. For example, when the trigger is depressed by an operator the reader may operate in a discontinuous mode and when the trigger is released the reader may switch to continuous mode after a predetermined period of time. A scanning subroutine may specify an address buffer space or spaces in which scan data is stored and whether scanning is to be continuous or discontinuous. Another example of switching between continuous and discontinuous modes may be accomplished by symbology wherein switching between the modes depends on the type of symbology detected. The reader may stop attempting to decode a symbol after a predetermined time limit. The reader, may limit the type of symbols to decode when in the continuous mode.

The aiming pattern generator may be programmed to operate in either continuous or discontinuous modes.

In the continuous mode, the present device may be configured to automatically switch to a reduced power state if no symbol has been sensed for a period of time. Upon sensing of a symbol the scanner may then automatically switch back to the higher power state continuous mode. In this reduced power state the scanner may change from having the aimer and/or illumination light sources on for every scan to having either/or on for only some of the scans (e.g. every 2 or 3 or less scans). In this manner the system may still be in a position to sense the presence of a symbol, but will draw less current and also generate less internal heating. After sensing a symbol, the image reader may utilize aiming/illumination for every scan until another period of inactivity is sensed.

Mode changes may be accomplished by the host computer in response to an appropriate signal over either a direct connection or wireless connection to the scanner.

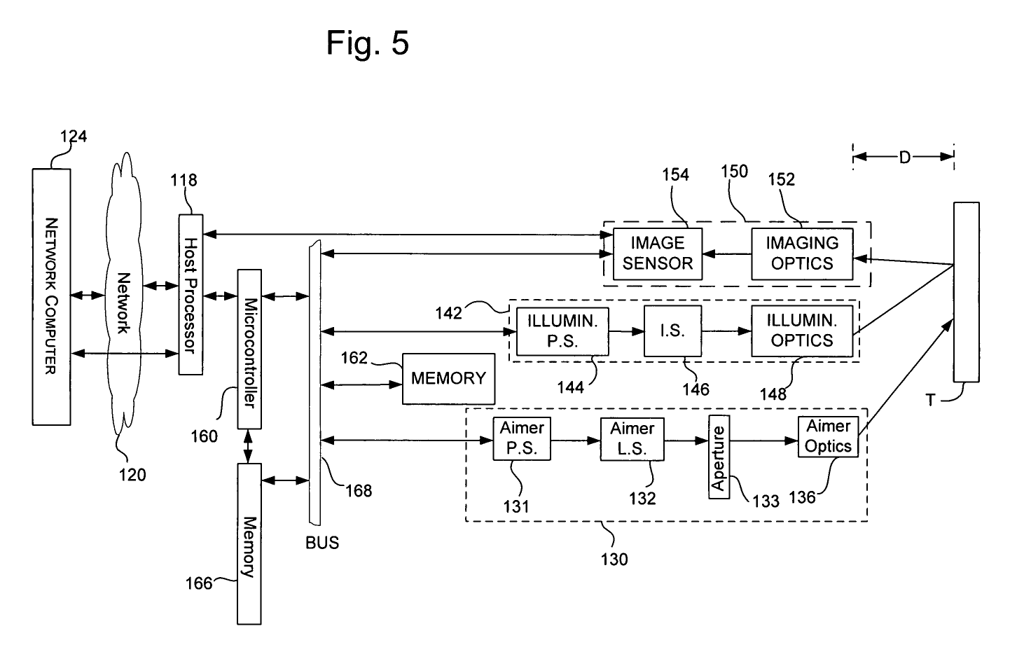

An embodiment in accordance with the present invention is shown in FIG. 5, which is similar to that shown in FIG. 4 except that memory 162 is not part of or integral with the microcontroller 160. The microcontroller 160 may be located remotely from optical reader 112 or subsystems thereof. If so, memory device 166 may be located on the PCB for storing the aforementioned parameters. The bus 168 may still be utilized for data transfer. An alternate connection might also be utilized for communication between the microcontroller 160 and other components of image reader. In an exemplary embodiment, the microcontroller may not be used and some of the functionality thereof may be performed by the host processor.

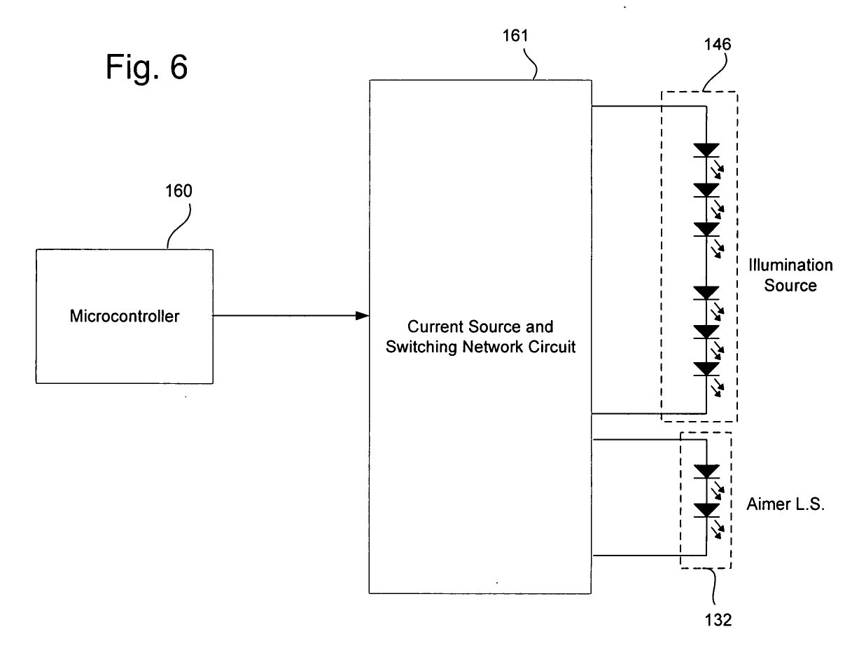

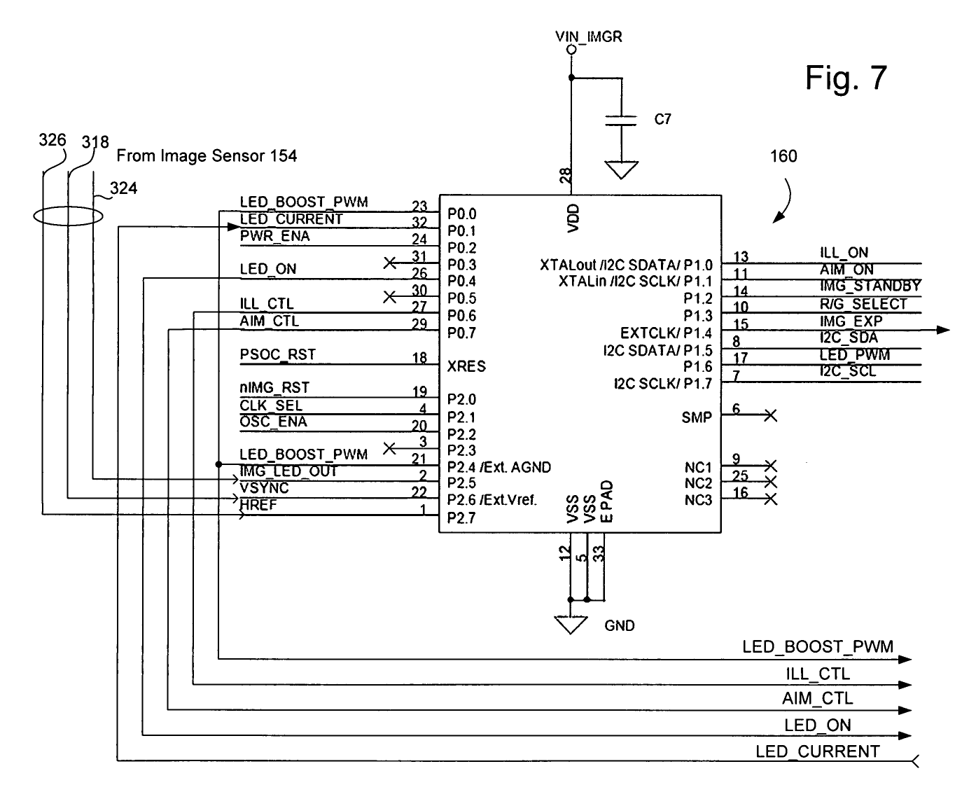

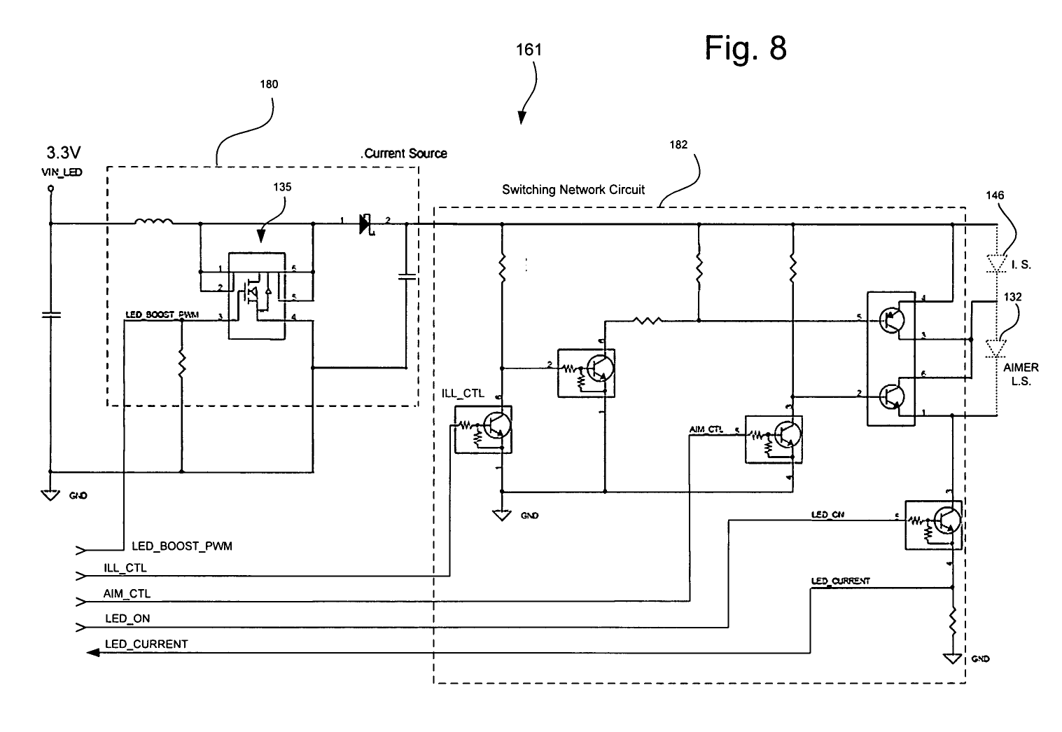

Referring to FIGS. 6, 7 and 8, microcontroller 160 may be a dual functional element comprised of a current source 180 and switching network circuit 182 for driving the illumination source 146 and aimer light source 132. Current source 180 may have a N-Channel Logic Level PowerTrench MOSFET such as FDG315N from Fairchild Semiconductor International. Microcontroller 160 controls the current to the illumination LEDs via the ILL_CTL output line and current to the aimer LEDs via the AIM_CTL line. Control of current source 180 is provided by the LED_BOOST_PWM output of the microcontroller 160. Feedback to microcontroller 160 is provided via LED_CURRENT.

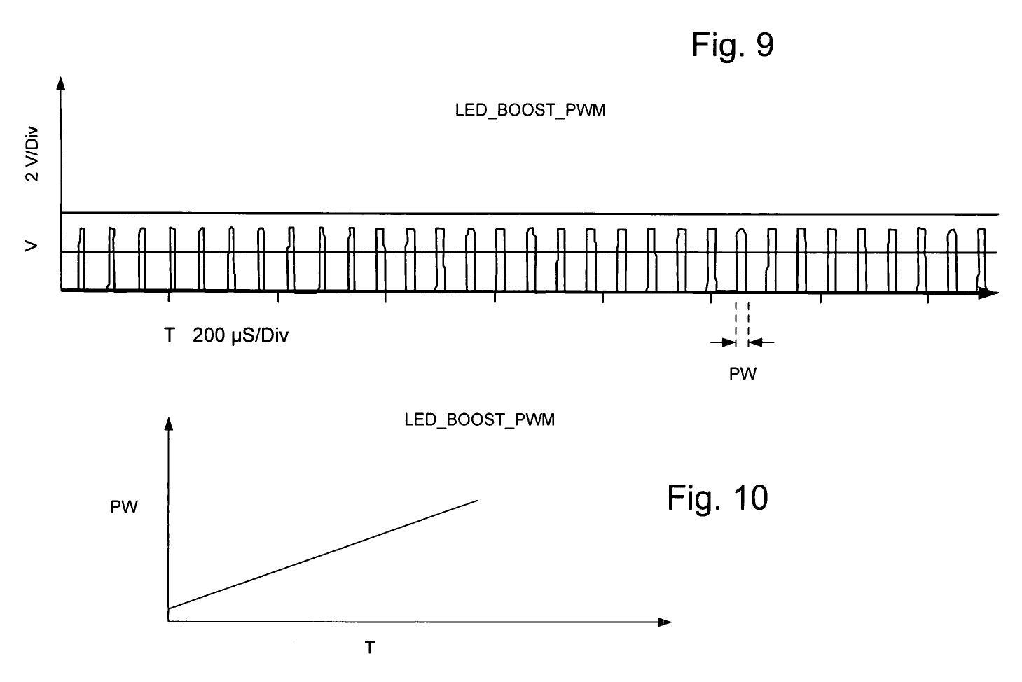

Referring to FIG. 9, an exemplary LED_BOOST_PWM signal for controlling the current source 131 is provided by image processor 160. The pulse width of the signal is dynamic in that it changes with time during the illumination period, which has the effect of ramping the current provided to the illumination source up.

Referring to FIG. 10, a graph of exemplary pulse width modulation of the LED_BOOST_PWM signal is illustrated. The pulse width of the signal is dynamic in that it changes with time during the illumination period, which has the effect of ramping the current provided to the illumination source up to prevent power supply current spikes. The signal may be a stepwise increase in nominal current.

In an alternate aiming generator embodiment, FIG. 11 illustrates a schematic diagram of an exemplary control circuit 138 for driving a laser aimer light source having a laser diode 137.

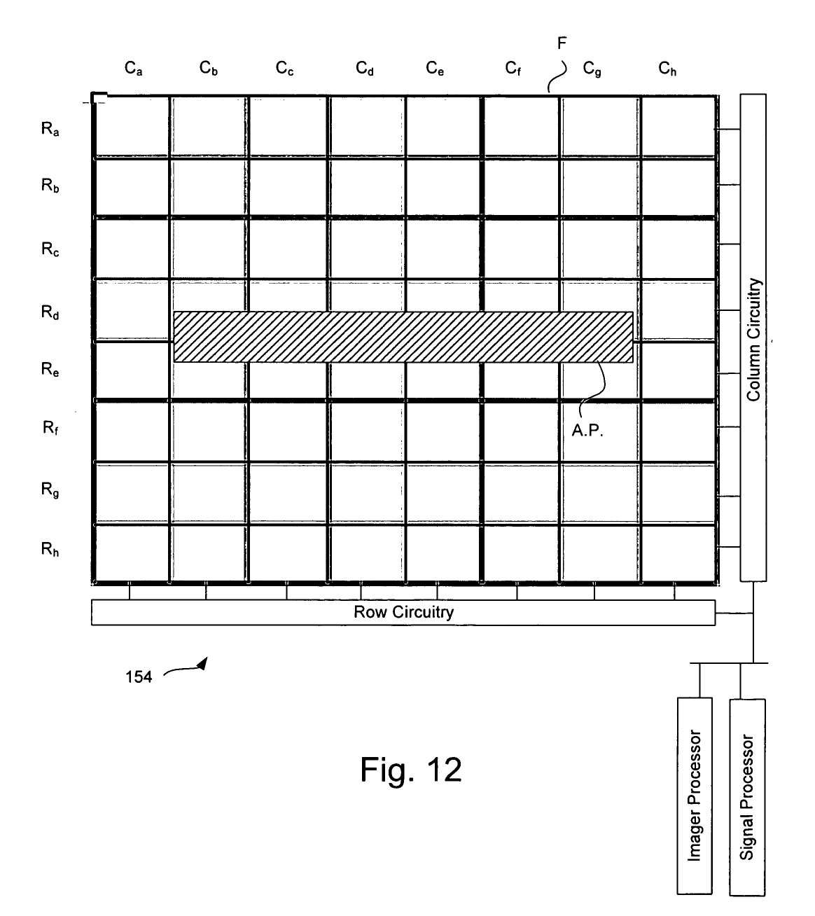

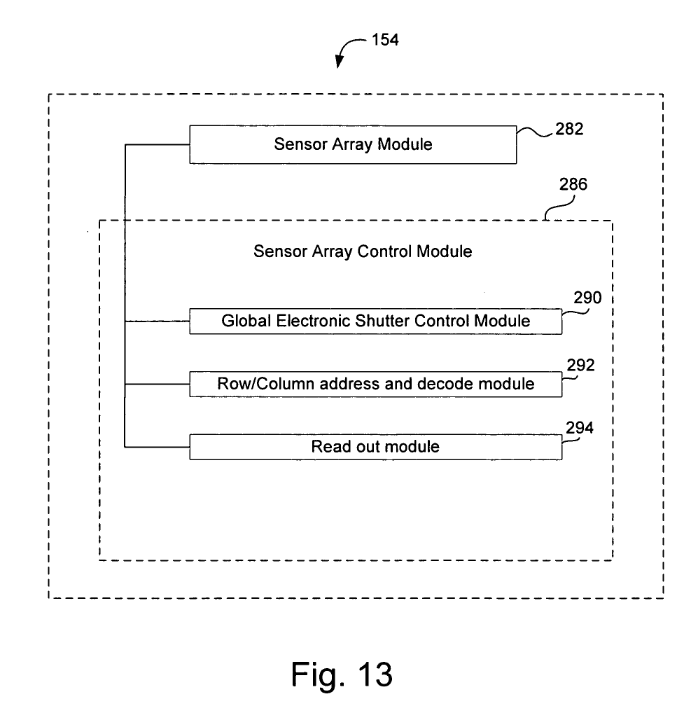

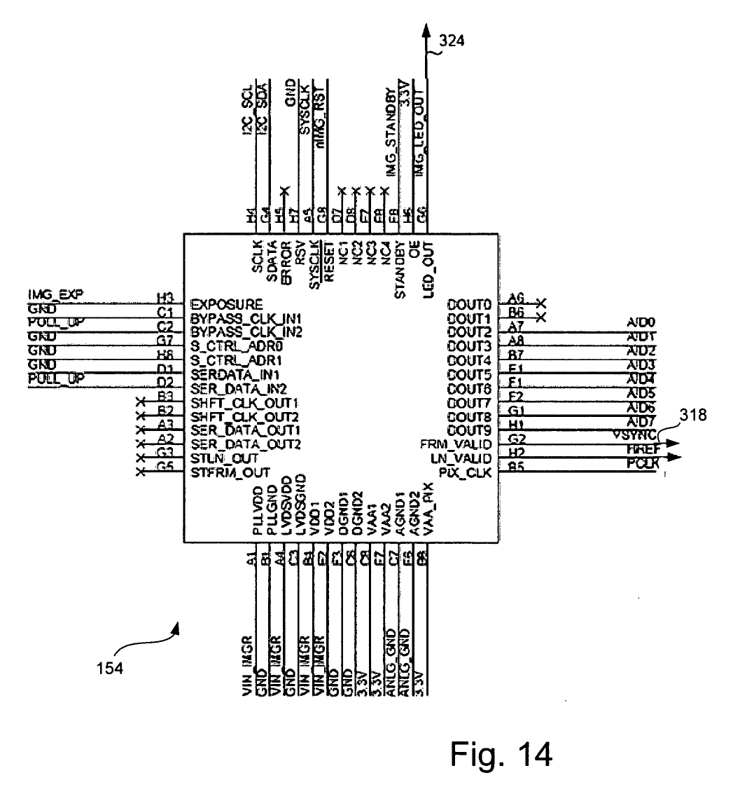

Referring to FIGS. 12, 13, 14, an exemplary image sensor 154 is illustrated in block and schematic diagram form, wherein a two-dimensional array of pixels is incorporated in image sensor array adapted to operate in a global shutter operating mode. Row circuitry and the column circuitry may enable one or more various processing and operational tasks such as pixel addressing counters, addressing decoding circuitry, amplification of signals, analog-to-digital signal conversion, applying timing, read-out and reset signals and the like. Decoding of the image may also be performed by an image sensor 154 having an integrated processor. F represents the frame (pixel array) and A.P. represents an image of an aiming pattern projected incident on the target. The image sensor 154 may be comprised of a sensor array module 282 and a sensor array control module 286. The sensor array control module may include a global electronic shutter control module 290, a row and column address and decode module 292, and a readout module 294, each of which modules is in electrical communication with one or more of the other modules in the image sensor 154. In one embodiment, the sensor array module 282 may include an integrated circuit with a two-dimensional CMOS based image sensor array. In various embodiments, associated circuitry such as analog-to-digital converters and the like may be discrete from the image sensor array or integrated on the same chip as the image sensor array. In an alternative embodiment, the sensor array module 282 may include a CCD sensor array capable of simultaneous exposure and storage of a full frame of image data. The global electronic shutter control module 290 may be capable of globally and simultaneously exposing substantially all of the pixels in the image sensor array. In one embodiment, the global electronic shutter control module 290 may include a timing module. The row and column address and decode module 292 may be used to select particular pixels. The readout module 294 may organize and process the reading out of data from select pixels of sensor array.

An exemplary image sensor 154 is manufactured by Micron Technology, Inc. and has a product number MT9V022, which may receive and provide a number of control signals. For example, a VSYNC (318) output signal indicates the beginning and/or end of each image frame F. An exposure control timing signal output IMG_LED_OUT (324) is a signal indicative of image sensor exposure occurring.

Further description of image sensor operation is provided in commonly owned U.S. patent application Ser. No. 11/077,995 entitled “BAR CODE READING DEVICE WITH GLOBAL ELECTRONIC SHUTTER CONTROL” filed on Mar. 11, 2005, which is hereby incorporated herein by reference in it's entirety.

It is to be noted that FIG. 12 is an exemplary illustration only, wherein typical image sensor matrixes have many more pixels, rows and columns than that shown.

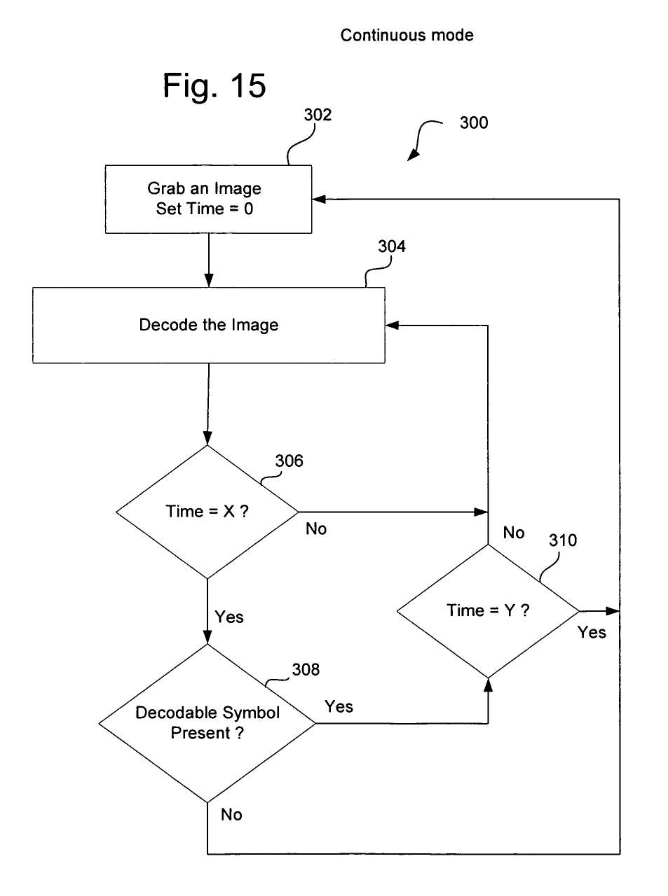

Referring to FIG. 15, a process 300 for decoding an image has a step 302 wherein the decoder grabs an image and sets a time to zero, wherein “grabbing” may mean the decoder receives or accepts the last image captured by the image sensor 154, and wherein the reader is in a continuous mode of operation. The decoder then begins decoding or attempts to decode the image in a step 304.

While decoding, the elapsed time since image grab is monitored in a step 306 to determine if a predetermined amount of time X has elapsed. If no, the decoder continues to decode. If X time has elapsed without a successful decode, a query is made whether evidence of a decodable symbol is present in the image in a step 308. Evidence may be defined as structure in the image representative of readable indicia, such as decoded code words of a specific symbology which have not yet yielded enough information to successfully decode. It may be different dependant upon, but not limited to, the structure of specific types of indicia or characteristics of specific symbologies. If evidence of a decodable symbol is not present, then next most recent image is grabbed for decoding. If evidence of a decodable symbol is present, then a query is made in a step 310 whether a predetermined amount of time Y has elapsed, where Y is greater than or equal to predetermined time X. If time Y has elapsed, then the next most recent image is grabbed for decoding. If time Y hasn't elapsed, the decoder continues to decode the image.

Times X and Y may be known as programmable “time outs”, which may be set in accordance with desired operating performance or environmental conditions. Decoding might time out for a number of reasons, such as excessive motion (target or reader), an out of focus target, a noisy image, a bad or broken image, incomplete information in the image, an unreadable or unknown symbol, etc.

When the decoder checks the time and realizes that time X has elapsed since the current image has been grabbed, it may trigger the exit of a decode attempt on a given image because there is no evidence of decodable indicia in the image. If evidence of decodable indicia does exist, the decoder continues to check the time elapsed since the current image is grabbed, but now checks to see if Time Y has elapsed where Y is greater than or equal to X. If the decoder checks the time and realizes that Time Y has elapsed, but still has not successfully decoded a readable piece of indicia, the decoder will exit and grab a new image to process.

There are cases where Time X or Time Y may be exceeded even when the criteria for the exit of a decode are met. Time X may be exceeded even when no evidence of decodable indicia is present due to the amount of time which passes between instances when the time is checked. The same is true for Time Y. Processing may continue after Time Y due to the amount of time which passes between instances when the time is checked. The reason for this is that some processing algorithms are complex, and depending on the specific algorithms, they may be allowed to complete before checking the timeout which can result in processing longer than a given timeout.

In discontinuous mode, (as might be used for hand held operation), decoding may be configured to run more aggressively for better depth of field and better reading of damaged or degraded symbols. This may involve longer decode timeouts to allow enhanced finding of difficult bar codes in the images, and also may include a difference in search methods to optimize for the center oriented use in a hand held environment. In a hand held environment the operator will typically aim the reader in the approximate direction of the symbol to be scanned. In the continuous mode however, there is no assurance of the presence of a symbol in the reader field of view, let alone a finder pattern. For this reason, the search methods in this mode are not typically center oriented. Similarly the maximum allowable exposure or integration time may be increased to allow the system to obtain a usable image at an increased scanning depth of field.

Referring to exemplary timing control diagram of the image reader in FIG. 16, a time period T_{F} represents the time period of data collection of an image frame F of the image sensor and is marked by transitions of a VSYNC signal 318. A time period T_{E} represents the exposure period of the image sensor and is marked by an up and down transition of a IMG_LED_OUT signal 324. T_{E} is the time during which the pixels are collectively activated to photo-convert incident light. At the end of T_{E} the collected charge is transferred to a shielded storage area until the data is read out. The time during which the target is illuminated is referred to as the illumination period marked by transitions of an ILL_CTL signal 322. The time during which the aimer LEDs are on is referred to as the aiming period represented by transitions of an AIM_CTL signal 320. A positive transition of a signal will herein be referred to as “on” and a negative transition of a signal will herein be referred to as “off”.

In FIG. 16, illumination is turned on at a time T_{I}. Thereafter, exposure of the image sensor array begins at a time T_{BE} and ends at a time T_{EE}. Image data is then read from the sensor array. This sequence begins again after the frame time period T_{F}.

In an exemplary aspect of the present invention, the exposure period T_{E} is about less than or equal to 1 mS and represents about 6 percent or less of the frame period T_{F}. The ratio of T_{E} to T_{F} is herein referred to as exposure duty cycle.

Another exemplary aspect is to allow a sufficient time period between the illumination control on signal 322 and the exposure on signal for the illumination source current (represented by a LED_CURRENT signal 328) to ramp up to maximum average current by the time exposure starts (T_{BE}).

If an aiming pattern is to be utilized, the aimer pattern generator may be turned on at a time T_{A} after the end of exposure TEE and turned off sometime before or at T_{BE}. An exemplary aspect of the present invention may be to control the on/off sequence of the illumination of the aiming pattern so that the aiming pattern is turned off during predetermined times of image collection, such as when data is being collected from the pixel matrix in areas where the aiming pattern is being projected or superimposed onto the target. It may be desirable to produce a digital image of the target without the aiming pattern superimposed on the picture, such as when operating the reader in a continuous mode.

In an exemplary embodiment, the aimer control timing pulse 320 may begin coincident with or after and finish coincident with or before the illumination control timing pulse 322. In further embodiments the exposure control timing pulse IMG_LED_OUT 324 and the illumination control timing pulse 322 overlap each other while occurring sequentially. In one such embodiment, this sequential operation may include the, illumination control timing pulse starting before the exposure control timing pulse starting, the illumination control timing signal pulse ending, and then the exposure control timing pulse ending.

The target may be illuminated by driving the illumination sources with a high peak current (such as about 50 mA or more), low duty cycle signal (such as about 6% or less which may be a 1 mS exposure for a 18 mS frame period) to generate high intensity illumination with low average LED current draw (such as 5 mA or less). In an exemplary embodiment, the LED illumination generated is about or on the order of ≧6.5 w/m² with an aperture one centimeter square on axis at about 5 inches from the front of the image reader with an exemplary range being about or on the order of between 6.5 w/m² and 9 w/m² or more with an aperture one centimeter square on axis at about 5 inches from the front of the image reader.

This exemplary illumination is controlled synchronously with the electronic global shutter and may allow for short exposure periods, such as exposure periods less than about 1 millisecond. Conditions may exist which permits imager frame time T_{F} to be reduced to about 1/(60 frames/sec) rate or less. That is, the bright illumination allows for a short integration time for each pixel and the global electronic shutter allows for all of the pixels in the image sensor to be simultaneously exposed while the illumination is active. With a short exposure period for a brightly illuminated target, an image reader of the present invention operated in continuous mode is able to collect a sharp non-distorted image even when the target is moving rapidly relative to the image reader. That is, motion tolerance may be increased allowing the ability to read moving symbols in continuous mode. In other words, reducing the exposure time reduces motion blur and allows for higher quality images to be acquired and used for decoding and image capture applications.

For example, an on-axis depth of field (DOF), at about a 100% read rate for a 100% UPC code may be accomplished with a target motion of about 20.8 inches per second at a reading range (taken from image reader face to target) of about 2″ to 7.25″.

In another example, an on-axis depth of field (DOF) at about a 100% read rate for a 80% UPC code may be accomplished with a target motion of about 20.8 inches per second at a reading range (taken from image reader face to target) of about 2″ to 6″.

While in continuous mode a 2D scanner may be optimized for peak illumination, aiming currents and imager frame rate. During periods of inactivity these features may be gradually scaled back to the point where just enough illumination is present for the image reader to detect target movement, thereby reducing average operating current and self heating. The scanner may then be returned to peak performance when a symbol is detected.

The present invention allows a 2D optical image reader to be utilized as a retail presentation capable scanner by having better target motion tolerance in order to read symbols seen at a point of transaction very quickly by operating the image reader in a continuous mode with very fast exposures and fast decoding by limiting the aggressiveness of the decode.

The present invention facilitates multiple distinct modes of operation depending on the type of symbol finder pattern that has been detected. A “finder pattern” is a fixed attribute of a bar code symbology which lets a decoding system know the data as a likely candidate of that symbology. For example, Maxicode has a circular bullseye in the middle Data Matrix has a “L” pattern across 2 adjacent sides, and the clocking pattern on the other 2 sides of this square symbology. Different finder patterns may not be exclusive to one symbology and finding one may not correspond to that given symbology. Finder patterns provide indications on what is being decoded and helps facilitate focusing the decoding method if it is indeed that symbology. Finder patterns are also intended to stand out so that background may be separated from the symbology.

In another example, PDF417 has a distinct bar/space patterns which run up and down the entire height of the symbology on both the right and left hand sides of the code itself. 1 D codes typically have unique “start” and “stop” patterns so that the bar/space patterns at the beginning or the end are unique to a given symbology. Also for most symbols, the quiet zones (areas of white space to each side of the bar code) may be considered part of the finder pattern. The image reader response time may be increased by not attempting to decode all possible bar code symbols simultaneously, rather based upon a finder pattern the system selects a decoder appropriate for the classes of bar code symbols being scanned. For example UPC, EAN and PDF417 might use decoders that are optimized for the specific symbology. The system decode time may thereby be reduced because the decoder is only attempting to decode a single family of bar code symbologies at a time.

Alternate imaging modes other than reading bar code symbols are contemplated herein. Another mode may involve optical character recognition (OCR), wherein the image is searched for text or pictures of characters and the decoder translates the images of typewritten text into machine-editable text, or into a standard encoding scheme representing them in ASCII or Unicode. The evidence of the data being scanned may determine how that data is scanned. Another mode may be for the capture of an image for storage and/or archiving.

The invention contemplates running decoding algorithms differently depending on the point of transaction (POT) situation. When scanning continuously in a presentation type of environment, continuous decoding may be very fast with very fast image turnover wherein the decoder spends little time on non-productive images or images without a symbology present. The timeouts for the decoder are set up and optimized to accomplish this. In another example, image decoding algorithms may perform uniform image search in the continuous mode and center weighted search in the discontinuous mode.

In discontinuous mode, (as might be used for hand held operation), decoding may be configured to run more aggressively for better depth of field and better reading of damaged symbols. This may involve longer decode timeouts to allow enhanced finding of difficult bar codes in the images, and also may include a difference in search methods to optimize for the center oriented use in a hand held environment. Similarly the maximum allowable integration (exposure) time may be increased to allow the system to obtain a usable image at an increased scanning depth of field. Integration time is the amount of time that charge is allowed to build up or accumulate in pixels in an array before the charge is dumped into a storage element, and eventually transferred off the imager as pixel data.

In the discontinuous mode, once a read is acquired after a trigger pull, the unit may wait a certain amount of time before going back to the continuous mode at which time decoding is reconfigured to be optimal in that situation again.

The present invention utilizes, amongst other things, LEDs and a programmable switching power supply to pulse the LEDs at high current and low duty cycle to provide a high intensity light source. Using the high intensity light source facilitates lower exposure times over the working DOF. As a result, short exposure times (about ≦1.3 mS) allow image motion tolerance to be increased to about ≧15 inches per second and even ≧20 inches per second in some cases. In other words reducing the exposure time decreases motion blur and allows for higher quality images to be acquired and used for decoding and image capture applications. Using a CMOS image sensor with global shutter exposure and driving illumination LEDs synchronously with exposure provides improved results. The LEDs thus dissipate less power and the thermal heating of the image engine and electronics is reduced allowing the image reader to maintain high efficiency on the LED boost supply and resulting in a high imager signal to noise ratio (SNR). Operating the image engine and illumination at a very high repetition rate makes the reader appear to a user to be operating in a continuous manner, thereby providing a product to read moving barcode labels, even in higher temperature environments where associated electronics can raise ambient temperature.

The present exemplary optical image reader or scanner provides certain benefits such as a decoding function that provides the capability to retrieve or read data omnidirectionally from machine readable indicia or symbol on an information bearing medium. Indicia to be read may take many forms, such as OCR of text, 2D symbology, 1D symbology, stacked linear symbology, matrix codes, optical marks, trademarks, identification graphics (state, country, company, etc.), pattern recognition, etc. Being an optical image reader also provides the ability to capture an image, or picture and convert it to a representative digital format for electronic storage or archiving.

An exemplary use of the exemplary optical reader is as the primary or sole scanner at a customer point of transaction (POT) in an establishment. Primary may mean the scanner at a POT is used to scan or image items more often than any other scanner or imager at the POT. A transaction may be any of a number of events that occur between a customer and an establishment, such as a store. The events may involve such things as exchange of monetary funds, payment for merchandise or service, return of merchandise, picking up merchandise that has already been paid for, or contracting for a service (such as leasing or renting).

As the primary scanner, merchandise with indicia can be read by it so that data decoded therefrom may be used for a stock keeping system (such as SKU) functionality such as sales, price look up, inventory, etc.

SKU is a common term for a unique numeric identifier, used most commonly in online business to refer to a specific product in inventory or in a catalog. A SKU is an identifier that is used by merchants to permit the systematic tracking of products and services offered to customers. Each SKU may be attached to an item, variant, product line, bundle, service, fee or attachment. SKUs are not always associated with actual physical items, but more appropriately billable entities. Each merchant using the SKU method will have their own personal approach to assigning the numbers, based on regional or national corporate data storage and retrieval policies. SKU tracking varies from other product tracking methods which are controlled by a wider body of regulations stemming from manufacturers or third-party regulations.

A picture may also be taken (or image captured) by the primary image reader at the POT for archival purposes, allowing the establishment to reference the picture or image at the time of the transaction or for the picture to be archived for use at a later time. For example, archiving may be for meeting statutory requirements, future identification, process compliance, fraud prevention, liability risk mitigation, forms completion, etc. An exemplary sequence at a POT may be for an employee to scan indicia from one or more items presented at the POT, and then take one or more pictures or images. The picture taken may be any of a number of items, such as a picture of the customer or an information bearing instrument or medium such as a customer presents one or more information bearing medium, which may be such things as personal checks or other items with signatures or identification instruments such as a credit card, boarding pass, flight ticket, employee badge, etc., or government identification instruments such as a driver's license, passport, military card, doctor's prescription Rx, etc. Information read from the picture taken may be used to electronically complete various types of forms, such as credit applications, statutorily required forms such as gaming licenses and firearm applications, photograph film development forms, rebate forms, merchandise lay away forms, extended warranty forms, etc. The process of extracting the information from the picture might include OCR, 2D barcode decoder such as PDF417 decoder, or matrix decoder such as Datamatrix, Aztec, QR code decoder, etc. To this end, a picture may be taken of the signature of the customer and archived or used for comparison with signatures which are already on file or stored. In another example, the scanner might read the applicants address from the PDF417 bar code on the drivers license and upon recognizing that the field being read is the applicants address, the system would then populate the address portion of the drivers license form automatically onto another application, such as an application or form for a hunting license, fishing license, firearms license, employment application, credit application, etc. Similarly the applicants date of birth, sex, and eye color could be filled in. Such a system would be more convenient while at the same time reducing application time and reducing application error rate because of incorrectly transcribed information. At the same time the scanner could be automatically changed to a picture taking mode, signal the operator to aim the scanner at the applicant, the drivers license, an article for purchase or rent, etc. and then take a picture. This picture could then also be automatically added to or associated with the electronic application being prepared. Part of the process might be allowing the applicant to look at the photo and accepting that the image is acceptable. If the appearance of the image is not acceptable, then a second alternate image might be taken and the process repeated until an image is taken that the applicant finds to be acceptable.

Also the image taken by the primary POT scanner might be used as a form of verification. The locally captured image might be compared with a database of images to authenticate the identity of the applicant. This might be done using the techniques such as described in U.S. Pat. No. 6,944,319 which is incorporated herein by reference.

In another implementation of the invention, a signature can be captured with the imager and this signature can be electronically placed into or associated with the application image or file, or it might be associated with the application in such a fashion that the licensing organization recognizes and accepts the signature authenticity.

In an exemplary embodiment, an affirmative or negative response depending on the presence or absence of the specified data type, such as a signature or a biometric, in the image data may be provided. Once the presence of a signature has been confirmed and its general orientation determined, image data may be used to detect the boundaries of the signature in the image data. The signature boundary may be detected using a histogram analysis which may consist of a series of one-dimensional slices along horizontal and vertical directions defined relative to the orientation of the signature. In one embodiment, the value for each one-dimensional slice corresponds to the number of black (i.e., zero valued) pixels along that pixel slice. In some embodiments if no bar codes have been decoded, then some specified region of the full frame of image data, such as a central region is captured for signature analysis. Once completed, the histogram analysis provides a two-dimensional plot of the density of data element pixels in the image data. The boundary of the signature is determined with respect to a minimum density that must be achieved for a certain number of sequential slices. In one embodiment, the histogram analysis searches inwardly along both horizontal and vertical directions until the pixel density rises above a predefined cutoff threshold. So that the signature data is not inadvertently cropped, it is common to use low cutoff threshold values.

In one embodiment, once the boundaries of the signature have been determined, the signature data processing crops the image data and extracts the signature image data. In one such embodiment, cropping generates modified image data in which a portion of the image data not including the signature has been deleted. In other embodiments, various compression techniques are employed to reduce the memory requirements for the signature image data. One such technique includes the encoding of the signature image data by run length encoding. According to this technique, the length of each run of similar binarized values (i.e., the length of each run of 1 or 0) for each scan line is recorded as a means of reconstructing a bit map. Another encoding technique treats the signature image data as a data structure where the elements of the data structure consist of vectors. According this encoding technique, the signature is broken down into a collection of vectors. The position of each vector in combination with the length and orientation of each vector is used to reconstruct the original signature. In one such embodiment, the encoding process generates a new vector whenever the curvature for a continuous pixel run exceeds a specified value. A further compression technique employs B-Spline curve fitting. This technique has the capacity to robustly accommodate curvature and scaling issues.

In another embodiment, the signature data processing does not perform a histogram analysis but simply stores in memory the entire image or a compressed version once the presence of a signature has been determined. In a further embodiment to save processing time, the initial image analysis is performed on a lower resolution image. Once the presence of a signature is determined in this embodiment, a higher resolution image is taken. In one embodiment, a signature extraction histogram analysis is performed on this image. Next, the image is stored in memory in either compressed or original format. In some embodiments, the image data is combined with other data to form a record for a particular item such as a package or shipping envelope. As mentioned above, some of the additional data that may be collected by the image reader and stored with or separate from the signature data includes but is not limited to dataform data, handwritten text data, typed text data, graphics data, image or picture data, and the like.

Additional image processing operations which may be carried out by image reader are described in U.S. patent application Ser. No. 10/958,779, filed Oct. 5, 2004 entitled, “System And Method To Automatically Discriminate Between A Signature And A Bar code” which is incorporated herein by reference in its entirety.

Numerous factors can lead to a bar code being unreadable. A bar code symbol can become degraded from extended use, for example, if a wand or other contact reader is swiped across a bar code numerous times. Dust or debris collecting on a bar code, as in a factory or other industrial setting can also negatively affect the capacity of a bar code symbol to be decoded by a reader. The most prevalent forms of degradation may occur during the printing process, for example ink smearing, improper encodation of the required information, use of improper ink resulting in insufficient bar to space contrast and improperly dimensioned photographic masters. The type of bar code reader being used to read a symbol also has an impact on readability. High quality bar code readers having improved processing functionality and/or improved hardware are able to decode bar code symbols that other bar code readers cannot. Another factor affecting a bar code symbol's capacity to be decoded is the print quality of the bar code symbol. Bar codes that are printed in accordance with high quality standards can withstand degradation such as caused by use or debris accumulation, and can be read by a variety of bar code readers from high to low quality.

Bar code print quality has an impact on the capacity of a bar code symbol to be successfully decoded. The scanner or image reader 112 may be utilized to extract bar code quality information from the bar code scanned or attempting to be scanned. This information might be stored with or associated with the bar code data such that the establishment can obtain real time data about the quality of the bar code symbols provided by the manufacturer. This action might also occur when an operator has to key in a bar code symbol because of a non-read. The system might also save an image of the next bar code attempted to be decoded just prior to keying in the information or alternately the last image detected immediately after this is scanned. Such parameters as relative symbol contrast, bar to space ratios and wide to narrow ratios may be saved.

The scanner 112 may be used to check symbols to the American National Standards Institute (ANSI) established guidelines for verifying bar code symbol print quality. Standards for verifying bar code symbol print quality are also provided in standards promulgated jointly by the International Standards Organization (ISO) and the International Electrotechnical Commission (“IEC”). According to the above referenced standards, bar code symbols may be subject to several quality measurements and may be allocated a numerical or letter grade ranging from zero (F) to 4.0 (A). A higher grade means that the bar code is more likely to be successfully decoded, whereas a lower grade means that the bar code is less likely to be successfully decoded. Historically, the Quality Specification for the UPC Printed Symbol, published by the Uniform Code Council, Inc. of Dayton Ohio, established guidelines for evaluating UPC Codes.

The processor or controller of the reader attempts to decode a bar code symbol represented in the captured image data and may perform various measurements to grade the bar code symbol in accordance with bar code decoding and print quality measurement programs stored in memory. The capture of image data, decoding, and measurement of print quality by processing of image data may occur automatically in response to a trigger signal being received or actuated. The trigger signal may come from any of a number of devices, such as a trigger, a control button from a spaced apart device, a host processor assembly, etc.

It is to be noted that the present image reader effectively turns every POT into a potential customer service counter where transactions typically involve return of merchandise, application completion, information dispersion, etc. with the image reader being the primary image reader.

In another implementation of the invention, a scanner may be used at a POT to capture an image having textual information. The scanner system may perform optical character recognition (OCR), wherein the image is searched for text or pictures of characters and the decoder translates the images of typewritten text into audible text via a speaker, so that an operator or customer may hear the text being read from the image. This may be beneficial to sight impaired people. It also eliminates the need for an operator or customer to have to read the text on a screen.

Referring now to FIG. 17, a stand 402 may be used to hold a scanner, such as scanner 112 while items (such as items with information bearing mediums) are moved through the field of view of the scanner. The stand might be equipped with a holder 404 for holding an item 406 (such as a driver license) in a location and placement which is optimal for imaging that item. The stand may have a reading instrument or detector 408, such as an RFID reader and associated circuitry/connectivity wherein a user may process RF payments or for article detection. The stand may also have a proximity reader for detecting or reading information from items placed in proximity to the stand. A proximity detector may be utilized to trigger the scanner for such things as activating illumination, activating an aimer, changing decoding algorithms, etc. The scanner may be constructed to sense that it is in the stand and there by change the operating mode when it is either inserted into the stand or removed from the stand. rather than rely upon a trigger pull to change the operating mode. This could be a mechanical switch that is activated when the scanner is placed in the stand. It might also be a microswitch that is activated by a mechanical feature in the scan stand. It might also consist of the magnetically actuated read relay the responds to a small permanent magnet built into the scan stand itself, or alternately perhaps even molded into the stand. The stand may also be equipped with a nose cone 410 for optimal placement of items within the field of view of the scanner. The cone 410 may be transparent to allow an operator to continue to see an item while scanning the item.

The image reading system of the present invention may have automatic switching between continuous mode and discontinuous mode. An exemplary switching method between these modes may be accomplished with a stand detector 408 to detect whether the imager is on the stand. If the imager is on the stand, then the image reader switches to continuous mode whereas if it switches to discontinuous mode when not in the stand. The detector may be implemented in various technologies including optical sensing, electromagnetic sensing, or mechanical sensing. For optical sensing, detector may have bar code type attributes that may be read by the image reader. When the imager detects a specific bar/space sequence, then it will automatically switch to continuous mode, otherwise, it will switch to the handheld mode. For electromagnetic sensing, the detector may be a magnet. For mechanical sensing, the detector may be a switch located in a position in which placement of the image reader is placed in the stand the switch is depressed.

As noted herein, stand 402 may also have a light source 414 for providing an illumination source which may be complementary or in addition to any illumination source provided in the scanner 112.

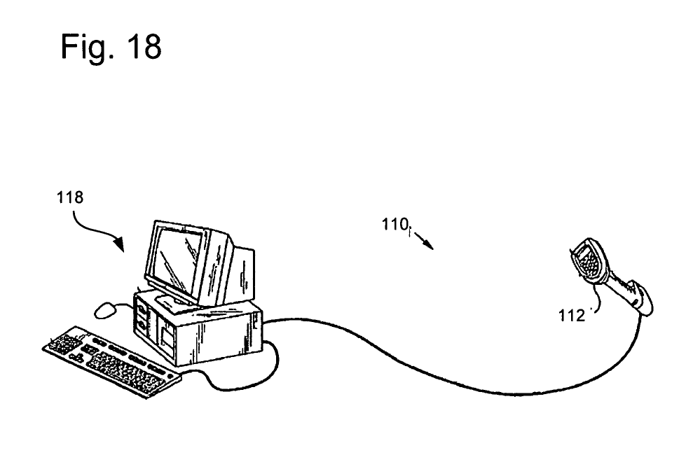

FIG. 18 illustrates an exemplary optical reading system.

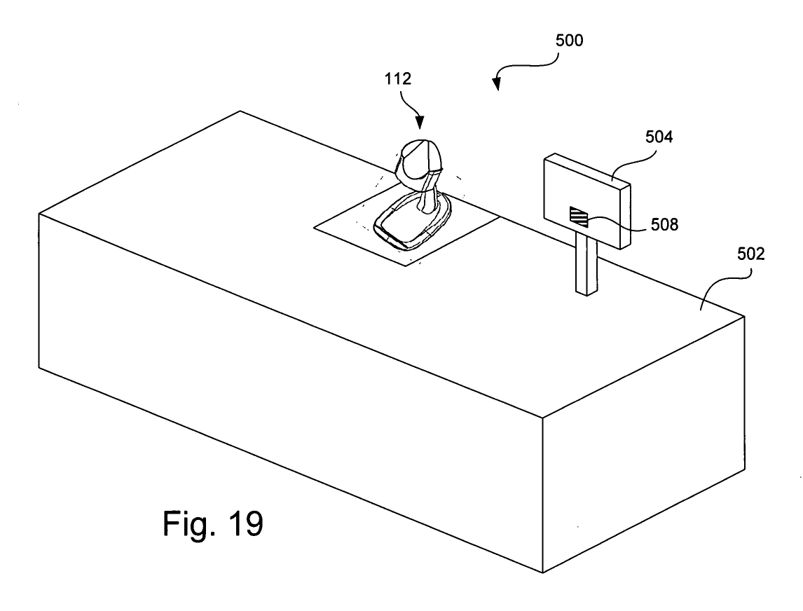

Referring to FIG. 19, an exemplary POT system 500 may include a primary image reader 112 located at or near a counter 502 which may represent a point of transaction POT. A display 504 may be present to display various information, forms, etc., including information obtained by or derived from the image reader 112. A speaker 508 may be included for broadcasting information derived from captured images, such provided in documents imaged.

It should be understood that the programs, processes, methods and apparatus described herein are not related or limited to any particular type of computer or network apparatus (hardware or software). Various types of general purpose or specialized computer apparatus may be used with or perform operations in accordance with the teachings described herein. While various elements of the preferred embodiments have been described as being implemented in software, in other embodiments hardware or firmware implementations may alternatively be used, and vice-versa. The illustrated embodiments are exemplary only, and should not be taken as limiting the scope of the present invention. For example, the steps of the flow diagrams may be taken in sequences other than those described, and more, fewer or other elements may be used in the block diagrams. Also, unless applicants have expressly disavowed any subject matter within this application, no particular embodiment or subject matter is considered to be disavowed herein.

1. An optical reading device for collecting and processing symbology data comprising:
an image sensor array of pixels for converting light reflected from a target containing a machine readable indicia into output signals representative thereof, the image sensor being operated in a global shutter mode wherein all or substantially all of the pixels in the array are exposed simultaneously during an exposure time;
receive optics for directing light from the target to the image sensor array, the optics having a receive optics optical axis;
a processor for decoding the output signals;
an illumination source for generating illumination light illuminating the target and illumination optics for directing the illumination light onto the target;
a housing encapsulating the image sensor array, receive optics and illumination source;
wherein the processor decodes in a first mode to continuously process available output signals automatically and a second mode to output signal in response to an activation event.

2. An optical reading device in accordance with claim 1, wherein the exposure time is less than 1 ms.

3. An optical reading device in accordance with claim 1, wherein the illumination source provides illumination of ≧6.5 w/m² with an aperture one centimeter square on axis at about 5 inches from the front of the image reader.

4. An optical reading device in accordance with claim 1, wherein the illumination source provides illumination of on the order of between 6.5 w/m² and 9 w/m² or more with an aperture one centimeter square on axis at about 5 inches from the front of the image reader.

5. An optical reading device in accordance with claim 1, wherein the processor is capable of decoding symbology on a target moving on the order of ≧20 inches per second.

6. An optical reading device in accordance with claim 1, further comprising an operator operated trigger associated with the optical reading device and wherein the second operating mode is enabled by the trigger.

7. An optical reading device in accordance with claim 1, wherein the image sensor array is a complementary metal oxide (CMOS) sensor array.

8. An optical reading device in accordance with claim 1, wherein the processor utilizes a time out limit for decoding, and the time out limit for the first mode of operation is longer than the time out limit for the second mode of operation.

9. An optical reading device in accordance with claim 1, wherein the processor switches between the first and second modes depending on the type of symbology detected.

10. An image reader in accordance with claim 1, wherein the processor stops attempting to decode a symbol after a predetermined time limit.

11. An image reader in accordance with claim 1, wherein the processor limits the types of symbols to decode when in the first mode.

12. An image reader in accordance with claim 1, wherein the illumination optics has an illumination optical axis and wherein the angular difference between the illumination optical axis and receive optical axis is greater than on the order of 4 degrees.

13. An image reader in accordance with claim 1, wherein the optical reading device is adapted for hand held operation.

14. An image reader in accordance with claim 1, wherein the optical reading device is portable.

15. An image reader in accordance with claim 1, wherein the optical reading device is battery powered.

16. A method of operating an optical reading device for collecting and processing indicia data comprising the steps of:
converting light reflected from a target into output signals representative thereof, utilizing an image sensor having an array of pixels, the image sensor being operated in a global shutter mode wherein all or substantially all of the pixels in the array are exposed simultaneously during an exposure time;
directing light from the target to the image sensor array utilizing receive optics, the optics having a receive optics optical axis;
decoding information contained in machine readable indicia within the target derived from the output signals utilizing a processor;
illuminating the target utilizing an illumination source and illumination optics for directing the illumination light onto the target;
encapsulating the image sensor array, receive optics and illumination source in a housing;
wherein the processor decodes in a first mode to continuously process available output signals automatically and a second mode to process available output signals in response to an activation event.

17. A method in accordance with claim 16, wherein the exposure time is less than 1 ms.

18. An optical reading device in accordance with claim 16, wherein the illumination source provides illumination of ≧6.5 w/m² with an aperture one centimeter square on axis at about 5 inches from the front of the image reader.

19. An optical reading device in accordance with claim 16, wherein the illumination source provides illumination of on the order of between 6.5 w/m² and 9 w/m² or more with an aperture one centimeter square on axis at about 5 inches from the front of the image reader.

20. An optical reading device in accordance with claim 16, wherein the processor is capable of decoding symbology on a target moving on the order of ≧20 inches per second.

21. An optical reading device in accordance with claim 16, further comprising an operator operated trigger associated with the optical reading device and wherein the second operating mode is enabled by the trigger.

22. An optical reading device in accordance with claim 16, wherein the image sensor array is a complementary metal oxide (CMOS) sensor array.

23. An optical reading device in accordance with claim 16, wherein the processor utilizes a time out limit for decoding, and the time out limit for the first mode of operation is longer than the time out limit for the second mode of operation.

24. An optical reading device in accordance with claim 16, wherein the processor switches between the first and second modes depending on the type of symbology detected.

25. An image reader in accordance with claim 16, wherein the processor stops attempting to decode a symbol after a predetermined time limit.

26. An image reader in accordance with claim 16, wherein the processor limits the types of symbols to decode when in the first mode.

27. An image reader in accordance with claim 16, wherein the illumination optics has an illumination optical axis and wherein the angular difference between the illumination optical axis and receive optical axis is greater than on the order of 4 degrees.

28. An image reader in accordance with claim 16, wherein the optical reading device is adapted for hand held operation.

29. An image reader in accordance with claim 16, wherein the optical reading device is portable.

30. An image reader in accordance with claim 16, wherein the optical reading device is battery powered.
